(19) United States
(12) Patent Application Publication
(10) Pub. No.: US 2025/0024770 A1
(43) Pub. Date: Jan. 23, 2025

(54) DOWNFORCE CONTROL SYSTEM FOR A SEEDING IMPLEMENT

(71) Applicant: CNH Industrial Canada, Ltd., Saskatoon (CA)

(72) Inventor: Nicholas George Alfred Ryder, Saskatoon (CA)

(21) Appl. No.: 18/224,510

(22) Filed: Jul. 20, 2023

(51) Int. Cl. A01B 63/32; A01B 63/00; A01C 5/06

(52) U.S. Cl. CPC A01B 63/32; A01B 63/008; A01C 5/068; A01B 63/22

(57) ABSTRACT

A row unit system for a seeder includes a frame, a parallel linkage configured to couple the frame to a mount associated with a toolbar of the seeder, an opener disc rotatably coupled to the frame, and a packer wheel assembly. The packer wheel assembly includes a packer wheel arm pivotally coupled to the frame, a packer wheel rotatably coupled to the packer wheel arm, and a packer wheel actuator pivotally coupled to the packer wheel arm and the frame, wherein the packer wheel actuator is configured to control a downforce applied by the packer wheel to soil.

### BACKGROUND

The present disclosure relates generally to a downforce control system for a seeding implement, and more particularly to a downforce control system that includes a parallel linkage and one or more downforce actuators.

Generally, a seeding implement (e.g., seeder) is towed behind a tractor or other work vehicle via a mounting bracket secured to a rigid frame of the seeding implement. The seeding implement typically includes multiple row units distributed across a width of the seeding implement. Each row unit is configured to deposit seeds at a target depth beneath a soil surface of a field, thereby establishing rows of planted seeds. For example, each row unit typically includes a ground engaging tool (e.g., opener disc) that forms a seeding path (e.g., trench) for seed deposition into the soil. A seed tube (e.g., coupled to the ground engaging tool) is configured to deposit seeds and/or other agricultural products (e.g., fertilizer) into the trench. The ground engaging tool and the seed tube may be followed by at least one wheel, such as a closing wheel that moves displaced soil back into the trench and/or a packer wheel that packs the soil on top of the deposited seeds.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In certain embodiments, a row unit system for a seeder includes a frame, a parallel linkage configured to couple the frame to a mount associated with a toolbar of the seeder, an opener disc rotatably coupled to the frame, and a packer wheel assembly. The packer wheel assembly includes a packer wheel arm pivotally coupled to the frame, a packer wheel rotatably coupled to the packer wheel arm, and a packer wheel actuator pivotally coupled to the packer wheel arm and the frame, wherein the packer wheel actuator is configured to control a downforce applied by the packer wheel to soil.

In certain embodiments, a row unit system for a seeder includes a frame, a parallel linkage configured to couple the frame to a mount associated with a toolbar of the seeder, an opener disc rotatably coupled to the frame, and a packer wheel assembly. The packer wheel assembly includes a rigid packer wheel arm pivotally coupled to the frame, a packer wheel rotatably coupled to the rigid packer wheel arm, and a packer wheel actuator pivotally coupled to the rigid packer wheel arm and the frame. A controller is configured to control a valve assembly to control a downforce applied by the packer wheel to soil.

In certain embodiments, a method of operating a row unit system for a seeder includes linking, via a parallel linkage, a frame of a row unit to a mount associated with a toolbar of the seeder. The method also includes positioning an opener disc in contact with soil in a field, wherein the opener disc is rotatably coupled to the frame. The method further includes positioning a packer wheel in contact with the soil in the field, wherein the packer wheel is rotatably coupled to a rigid packer wheel arm, and the rigid packer wheel arm is pivotally coupled to the frame. The method further includes controlling a valve assembly to increase a fluid pressure at a packer wheel actuator that is coupled to the rigid packer wheel arm to thereby decrease a downforce applied by the packer wheel to the soil in the field.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural seeding implement;

FIG. 2 is a side view of an embodiment of a row unit that may be employed within the agricultural seeding implement of FIG. 1, wherein an opener disc is coupled to a frame of the row unit; and

FIG. 3 is a side view of an embodiment of a row unit that may be employed within the agricultural seeding implement of FIG. 1, wherein multiple actuators are positioned to adjust respective downforce applied by a gauge wheel and a packer wheel of the row unit.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

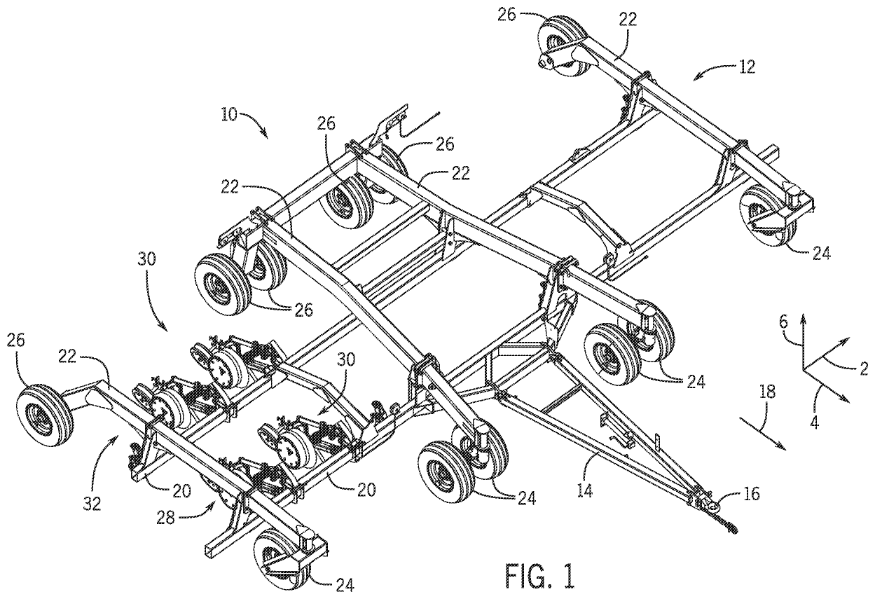

FIG. 1 is a perspective view of an embodiment of an agricultural seeding implement 10 (e.g., seeder). The agricultural seeding implement 10 may include a frame 12 (e.g., implement frame) and a tow bar 14 coupled to the frame 12. The tow bar 14 may be coupled to the frame 12 and include a hitch 16. The hitch 16 may be configured to interface with a corresponding hitch of a work vehicle (e.g., tractor), thereby enabling the work vehicle to tow the agricultural seeding implement 10 through a field along a forward direction of travel 18.

It should be appreciated that the tow bar 14 may have any suitable configuration (e.g., A-frame; a single bar) and may be either pivotally or rigidly coupled to the frame 12. In addition, the agricultural seeding implement 10 may carry or be coupled to an air cart (e.g., via the hitch 16, and then the air cart may be coupled to the work vehicle such that the agricultural seeding implement 10 and the air cart are towed together by the work vehicle) that provides agricultural product (e.g., seeds, fertilizer) to the agricultural seeding implement 10 for distribution to soil in the field. Furthermore, the agricultural seeding implement 10 may be towed by the work vehicle or may itself be part of a self-propelled vehicle (e.g., in which the frame of the agricultural seeding implement 10 is coupled to a main frame/chassis of the self-propelled vehicle). Regardless of the configuration, the agricultural seeding implement 10 may travel via operator control or via autonomous control. For example, the agricultural seeding implement 10 may be towed by the work vehicle that operates under control of an operator in a cab of the work vehicle or that operates autonomously (e.g., autonomously or semi-autonomously via a control system executing autonomous driving algorithms). It should be appreciated that various configurations and arrangements of the agricultural seeding implement 10 are envisioned. For example, the air cart may be towed behind the agricultural seeding implement 10. As another example, the air cart may be mounted on the agricultural seeding implement 10 (e.g., on the frame 12; a mounted tank disk drill).

As shown, the frame 12 of the agricultural seeding implement 10 includes two toolbars 20 and four supports 22. Wheels are coupled to the supports 22, and the supports 22 are coupled to the toolbars 20 (e.g., via fasteners, via a welded connection). In particular, front wheel(s) 24 are rotatably coupled to a respective front portion of each support 22, and rear wheel(s) 26 are rotatably coupled to a respective rear portion of each support 22. The wheels 24, 26 maintain the supports 22 above a surface of the soil in the field and enable the agricultural seeding implement 10 to move along the forward direction of travel 18. Pivotal connections may be provided between the front wheel(s) 24 and the respective supports 22 to enable the front wheel(s) 24 to caster, thereby enhancing the turning ability of the agricultural seeding implement 10 (e.g., at a headland, during transport). It should be appreciated that the frame 12 of the agricultural seeding implement 10 may have any number of supports 22 (e.g., 0, 1, 2, 3, 4, 5, 6, or more). Furthermore, in certain embodiments, the toolbars 20 of the frame 12 may be supported by other and/or additional suitable structures (e.g., connectors extending between toolbars, wheel mounts coupled to toolbars).

As shown, a first row 28 of row units 30 is supported by a front toolbar 20, and a second row 32 of row units 30 is supported by a rear toolbar 20. The agricultural seeding implement 10 may have any number of toolbars 20 (e.g., 1, 2, 3, 4, 5, 6, or more) and corresponding rows of row units 30. For image clarity, FIG. 1 is simplified to show two row units 30 in the first row 28 of row units 30 and two row units 30 in the second row 32 of row units 30. However, it should be appreciated that any number or row units 30 (e.g., 1, 2, 3, 4, 5, 6, 7, 8, 10, 12, 20, 30, or more) may be provided across a width of the agricultural seeding implement 10.

In the illustrated embodiment, each row unit 30 of the agricultural seeding implement 10 is configured to deposit the agricultural product into the soil. For example, certain row units 30 (e.g., all of the row units 30 of the agricultural seeding implement 10, a portion of the row units 30 of the agricultural seeding implement 10, at least one row unit 30 of the agricultural seeding implement 10) may include an opener disc that is configured to form a trench within the soil for deposition of the agricultural product into the soil. The row unit 30 also includes a gauge wheel (e.g., positioned adjacent to the opener disc) configured to control a penetration depth of the opener disc into the soil. For example, the opener disc may be rotatably and non-movably coupled to a frame of the row unit 30, and the gauge wheel may be movably coupled to the frame of the row unit 30 and configured to contact a surface of the soil during operation of the row unit 30. Accordingly, adjusting the vertical position of the gauge wheel relative to the frame of the row unit controls the penetration depth of the opener disc into the soil. In addition, the row unit 30 includes a product tube (e.g., seed tube) configured to deposit the agricultural product into the trench formed by the opener disc.

The opener disc/agricultural product tube may be followed by a closing system. In the illustrated embodiment, the closing system includes a packer assembly having a packer wheel configured to pack the soil on top of the deposited agricultural product. In certain embodiments, each row unit 30 of the second row 32 is laterally offset (e.g., offset in a lateral direction perpendicular to the forward direction of travel 18) from a respective row unit 30 of the first row 28, such that two adjacent rows of agricultural product are established within the soil. To facilitate discussion, the agricultural seeding implement 10 and its components (e.g., the row unit 30) may be described with reference to a lateral axis or direction 2, a longitudinal axis or direction 4, and/or a vertical axis or direction 6.

As described herein, at least one row unit 30 (e.g., each row unit 30) may include one or more biasing members and/or one or more downforce actuators that are configured to affect and/or control downforce applied by ground-engaging components of the at least one row unit 30. For example, the row unit 30 may include one biasing member (e.g., spring) that is positioned to drive the frame of the row unit 30 toward the soil to affect the downforce applied by the gauge wheel to the surface of the soil and the downforce applied by the packer wheel to the surface of the soil. The row unit 30 may also include a downforce actuator (e.g., packer wheel actuator) that is positioned and operated to independently further affect and/or adjust the downforce applied by the packer wheel to the surface of the soil. As discussed herein, various configurations of the one or more biasing members and/or the one or more downforce actuators are envisioned to enable more efficient and/or effective seeding operations.

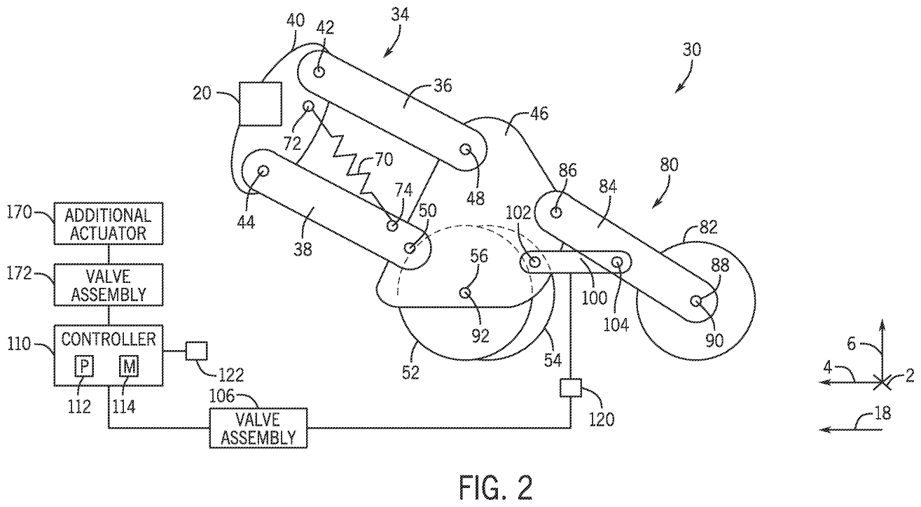

FIG. 2 is a side view of an embodiment of the row unit 30 that may be employed within the agricultural seeding implement 10 of FIG. 1. As shown, the row unit 30 includes a linkage assembly 34 configured to couple (e.g., pivotally couple) the row unit 30 to a respective toolbar 20 of the agricultural seeding implement. The linkage assembly 34 includes an upper link 36 and a lower link 38. A first end of the upper link 36 is pivotally coupled to a mount 40 (e.g., bracket) via a fastener 42 (e.g., pin), and a first end of the lower link 38 is pivotally coupled to the mount 40 via a fastener 44 (e.g., pin). The mount 40 may be a one-piece structure or a multi-piece structure that is associated with (e.g., configured to couple to; fixed or pivotally; directly or indirectly) to the respective toolbar 20 of the agricultural seeding implement.

In addition, a second end of the upper link 36 is pivotally coupled to a frame 46 of the row unit 30 via a fastener 48 (e.g., pin), and a second end of the lower link 38 is pivotally coupled to the frame 46 of the row unit 30 via a fastener 50 (e.g., pin). As shown, the upper link 36 and the lower link 38 are each coupled between the mount 40 and the frame 46 to be parallel to one another (e.g., form a parallel linkage). The linkage assembly 34 enables the frame 46 of the row unit 30 to move vertically (e.g., raise and lower in the vertical direction 6) relative to the mount 40 and the respective toolbar 20 (e.g., in response to an opener disc 52 and/or a gauge wheel 54 contacting an obstruction and/or due to variations in terrain).

As shown, the row unit 30 includes the opener disc 52 (e.g., opener; opener device or tool) rotatably and non-movably coupled to the frame 46 by a bearing assembly 56 (e.g., pin; axle). The bearing assembly 56 enables the opener disc 52 to freely rotate as the opener disc 52 engages the soil, thereby enabling the opener disc 52 to excavate a trench within the soil. The row unit 30 may also include the gauge wheel 54 configured to control a penetration depth of the opener disc 52 into the soil. The gauge wheel 54 is configured to rotate along the surface of the soil. Accordingly, adjusting the vertical position of the gauge wheel 54 relative to the frame 46 controls the penetration depth of the opener disc 52 into the soil.

The gauge wheel 54 is rotatably coupled to a gauge wheel support arm, and the gauge wheel support arm is pivotally coupled to the frame 46. In some embodiments, a depth adjustment handle may be coupled to the gauge wheel support arm, such that adjustment of the depth adjustment handle drives the gauge wheel 54 to move vertically relative to the frame 46, thereby controlling the penetration depth of the opener disc 52 into the soil. It should be appreciated that any other suitable depth adjustment assembly/device, such as an actuator, may be used to control the vertical position of the gauge wheel 54 and the penetration depth of the opener disc 52. In certain embodiments, the gauge wheel 54 is positioned against the opener disc 52 to remove soil from a side of the opener disc 52 during operation of the row unit 30. Furthermore, the row unit 30 includes an agricultural product tube (e.g., seed tube) configured to direct agricultural product into the trench formed by the opener disc 52.

In certain embodiments, the row unit 30 includes a spring assembly 70 (e.g., biasing member; biasing assembly) is configured to urge the opener disc 52 into engagement with the soil, to urge the gauge wheel 54 against the surface of the soil, and to enable upward vertical movement of the frame 46 (e.g., in response to contact between the opener disc 52 and an obstruction within the field). In some embodiments, the spring assembly 70 includes a bolt/tube assembly that connects a lower trunnion to an upper trunnion, and the bolt/tube assembly is surrounded by a compression spring. As shown, a first end of the spring assembly 70 is pivotally coupled to the mount 40 via a fastener 72 (e.g., pin), and a second end of the spring assembly 70 is pivotally coupled to the lower link 38 by a fastener 74 (e.g., pin). However, it should be appreciated that the first end of the spring assembly 70 may be pivotally coupled to the mount 40 via the fastener 72, and the second end of the spring assembly 70 may be pivotally coupled to the frame 46 via a respective fastener (e.g., pin). As another example, the first end of the spring assembly 70 may be pivotally coupled to the upper link 36 via a respective fastener, and the second end of the spring assembly 70 may be pivotally coupled to the lower link 38 by the fastener 74 or to the frame 46 via a respective fastener (e.g., pin). As another example, the first end of the spring assembly 70 may be pivotally coupled to the frame 46 via a respective fastener (e.g., pin), and the second end of the spring assembly 70 may be pivotally coupled to the lower link 38 by the fastener 74. Thus, the spring assembly 70 may be coupled to other components of the row unit 30 in any suitable arrangement that drives movement (e.g., pivoting; rotation) of the lower link 38 relative to the mount 40.

As shown, the row unit 30 also includes a packer assembly 80 (e.g., closing assembly) configured to close the trench formed by the opener disc 52 and to pack soil on top of the deposited agricultural product. The packer assembly 80 includes a packer wheel 82 and a packer wheel arm 84. The packer wheel arm 84 is pivotally coupled to the frame 46 via a fastener 86 (e.g., pin), and the packer wheel 82 is rotatably coupled to the packer wheel arm 84 via a bearing assembly 88 (e.g., pin; axle). The packer wheel arm 84 may be a one-piece and/or a rigid structure that extends between the fastener 86 at the frame 86 to the bearing assembly 88 at the packer wheel 82. A soil-contacting surface of the packer wheel 82 may have any suitable shape (e.g., v-shaped, flat) and/or any suitable tread pattern (e.g., chevron treads). In addition, the packer wheel arm 84 positions a rotational axis 90 of the packer wheel 82 rearward of a rotational axis 92 of the opener disc 52 relative to the forward direction of travel 18 of the row unit 30. In the illustrated embodiment, the packer wheel arm 84 is configured to pivot relative to the frame 46. Accordingly, the packer wheel arm 84 may pivot relative to the frame 46 in response to contact between the packer wheel 82 and an obstruction in the field and/or variations in terrain.

In the illustrated embodiment, the packer assembly 80 includes a packer wheel actuator 100 (e.g., closing wheel actuator; downforce actuator; fluid actuator, such as hydraulic cylinder, hydraulic motor, pneumatic cylinder, pneumatic motor) pivotally coupled to the frame 46 and the packer wheel arm 84. In particular, a first end of the packer wheel actuator 100 is pivotally coupled to the frame 46 via a fastener 102 (e.g., pin), and a second end of the packer wheel actuator 100 is pivotally coupled to the packer wheel arm 84 via a fastener 104 (e.g., pin). As shown, the first end of the packer wheel actuator 100 is pivotally coupled to the frame 46 via the fastener 102 at a respective location that is vertically below a respective connection between the packer wheel arm 84 and the frame 46 via the fastener 86. It should be appreciated that the first end of the packer wheel actuator 100 may instead be pivotally coupled to the frame 46 via the fastener 102 at a respective location that is vertically above the respective connection between the packer wheel arm 84 and the frame 46 via the fastener 86. Additionally, the second end of the packer wheel actuator 100 is pivotally coupled to the packer wheel arm 84 via the fastener 104 at a respective location that is in a middle portion of the packer wheel arm 84 (e.g., between the first end and the second end of the packer wheel arm 84; between a respective connection between the packer wheel arm 84 and the frame 46 via the fastener 86 and a respective connection between the packer wheel arm 84 and the packer wheel 82 via the bearing assembly 88). Such a configuration may provide various advantages, such as a low profile toward at rearward end of the row unit 30, for example. However, the packer wheel actuator 100 may be coupled to other components of the row unit 30 in any suitable arrangement that drives movement (e.g., pivoting; rotation) of the packer wheel arm 84 relative to the frame 46.

The packer wheel actuator 100 is configured to control downforce applied by the packer wheel 82 to the soil. For example, the downforce applied by the packer wheel 82 to the soil may be adjusted by varying a fluid pressure within the packer wheel actuator 100. More particularly, the downforce applied by the packer wheel 82 to the soil may be increased by decreasing a fluid pressure within the packer wheel actuator 100 (e.g., to compress or shorten the packer wheel actuator 100 to drive the packer wheel 82 toward the frame 46), and the downforce applied by the packer wheel 82 to the soil may be decreased by increasing the fluid pressure within the packer wheel actuator 100 (e.g., to extend or lengthen the packer wheel actuator 100 to drive the packer wheel 82 away from the frame 46).

A valve assembly 106 is fluidly coupled to the packer wheel actuator 100. The valve assembly 106 is configured to control the fluid pressure within the packer wheel actuator 100, thereby adjusting the downforce applied by the packer wheel 82 to the soil. While the packer wheel actuator 100 includes the fluid actuator in the illustrated embodiment, in other embodiments, the packer wheel actuator may include another or an alternative suitable actuating device, such as any electromechanical actuator, any linear actuator, any rotary actuator, and so forth. Furthermore, while the packer wheel actuator 100 includes a single actuating device in FIG. 2, it should be appreciated that the packer wheel actuator 100 may include multiple actuating devices (e.g., of the same type or of different types).

A controller 110 (e.g., electronic controller) is configured to output an output signal to the valve assembly 106 indicative of instructions to control the packer wheel actuator 100. As shown, the controller 110 includes a processor 112 and a memory device 114. The controller 110 may also include one or more storage devices and/or other suitable components. The processor 112 may be used to execute software, such as software for controlling the valve assembly 106. Moreover, the processor 112 may include multiple microprocessors, one or more “general-purpose” microprocessors, one or more special-purpose microprocessors, and/or one or more application specific integrated circuits (ASICS), or some combination thereof. For example, the processor 112 may include one or more reduced instruction set (RISC) processors.

The memory device 114 may include a volatile memory, such as random access memory (RAM), and/or a nonvolatile memory, such as read-only memory (ROM). The memory device 114 may store a variety of information and may be used for various purposes. For example, the memory device 114 may store processor-executable instructions (e.g., firmware or software) for the processor 112 to execute, such as instructions for controlling the valve assembly 106. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the first valve assembly), and any other suitable data.

The controller 110 may be located in/on the agricultural seeding implement, in/on an air cart coupled to the agricultural seeding implement, in/on a work vehicle coupled to the agricultural seeding implement, or in any other suitable location that enables the controller 110 to perform the operations described herein. It should also be appreciated that a respective controller may be provided for each row unit 30 (e.g., to control each row unit separately), a respective controller may be provided for a subset of row units (e.g., some of the row units; to control some of the row units together), or the controller may be provided for all of the row units (e.g., to control all of the row units together).

In certain embodiments, the controller 110 is configured to determine the instructions to control the packer wheel actuator 100 based at least in part on a contact force (e.g., determined contact force; measured contact force) between the packer wheel 82 and the soil. For example, as discussed in detail here, the controller 110 may determine a target contact force between the packer wheel 82 and the soil based on soil condition(s), residue characteristics (e.g., coverage), trench closing effectiveness, or a combination thereof. Then, the controller 110 may control the packer wheel actuator 100 such that the contact force between the packer wheel 82 and the soil is maintained within a threshold range of the target contact force.

In some embodiments, a downforce sensor 120 is configured to output an input signal to the controller 110 indicative of the contact force between the packer wheel 82 and the soil. In addition, the downforce sensor 120 includes a fluid pressure sensor fluidly disposed between the valve assembly 106 and the packer wheel actuator 100. The downforce sensor 120 may monitor the pressure of the fluid supplied to the packer wheel actuator 100, thereby enabling the controller 110 to determine the downforce applied by the packer wheel 82 to the soil based on the monitored pressure.

While the downforce sensor 120 may include fluid pressure sensors, it should be appreciated that the downforce sensor may include other suitable type(s) of sensor(s) configured to output respective input signal(s) indicative of the downforce (e.g., alone or in combination with the fluid pressure sensor). For example, in certain embodiments, at least one downforce sensor may include a torque sensor configured to monitor torque about the connection between the packer wheel arm 84 and the frame 46. Furthermore, in certain embodiments, at least one downforce sensor may include a strain gauge configured to monitor a bending force within the packer wheel arm 84. In addition, in certain embodiments, at least one downforce sensor may include a position sensor (e.g., ultrasonic transducer, capacitance sensor, inductance sensor, infrared sensor, radio frequency sensor, a sensor integrated within the respective actuator) configured to monitor an orientation of the packer wheel arm 84 relative to the frame 46. In such embodiments, the controller 110 may determine the downforce based on the orientation of the packer wheel arm 84 (e.g., a lower position of the packer wheel arm 84 may be indicative of a higher contact force, and a higher position of the packer wheel arm 84 may be indicative of a lower contact force). Furthermore, in certain embodiments, at least one downforce sensor may be omitted, and the controller 110 may provide open-loop control of the respective actuator.

As previously discussed, the controller 110 may determine the target contact force between the packer wheel 82 and the soil based on the soil condition(s), the residue characteristics, the trench closing effectiveness, or a combination thereof. In the illustrated embodiment, a soil sensor 122 is configured to output an input signal to the controller 110 indicative of a measured soil condition. In certain embodiments, the controller 110 is configured to determine the instructions to control the packer wheel actuator 100 based at least in part on the measured soil condition. The soil sensor 122 may include an electrical conductivity sensor configured to monitor soil moisture content. For example, if the controller 110 determines that the soil moisture content is high, the controller 110 may reduce (e.g., from a first higher contact force to a second lower contact force) the target contact force for the packer wheel 82 to reduce compaction of the soil by the packer wheel 82. While the soil sensor 122 may include an electrical conductivity soil moisture content sensor, it should be appreciated that the soil sensor 122 may include another suitable type of soil moisture sensor, such as a non-contact electrostatic sensor. Furthermore, the soil sensor 122 may include a sensor configured to monitor soil composition, soil firmness, soil density, or a combination thereof. Such sensors may include radio frequency transducer(s), infrared transducer(s), optical sensor(s) (e.g., camera(s)), LIDAR sensor(s), RADAR sensor(s), another suitable sensor type, or a combination thereof.

The controller 110 may adjust the target contact force for the packer wheel 82 based on the residue coverage (e.g., percentage of a surface area covered by residue, approximate depth of the residue, and/or approximate density of the residue) forward of the row unit 30 and/or rearward of the row unit 30. For example, if the residue coverage forward of the row unit is high, the controller 110 may decrease the target contact force (e.g., from a first higher contact force to a second lower contact force) for the packer wheel 82 to reduce compaction of the residue over the deposited agricultural product. Additionally or alternatively, if the residue coverage rearward of the row unit 30 is high, the controller 110 may decrease the target contact force (e.g., from a first higher contact force to a second lower contact force) for the packer wheel 82 to reduce compaction of the residue over the deposited agricultural product. A residue sensor 124 may include an optical sensor or any other suitable sensor configured to monitor residue coverage, such as a radio frequency transducer, an infrared transducer, a LIDAR sensor, or a RADAR sensor.

Because the packer wheel arm 84 is independently pivotally coupled to the frame 46 of the row unit 30, the contact force between the packer wheel 82 and the soil may be adjusted substantially independently of the contact force between the gauge wheel 54 and the soil. For example, the contact force between the gauge wheel 54 and the soil may be a first value (e.g., as detected based on sensor data) due to biasing applied by the spring assembly 70, and the contact force between the packer wheel 82 and the soil may be further adjusted to a second value via the packer wheel actuator 100. The contact force between the packer wheel 82 and the soil may be adjusted for particular field conditions (e.g., soil composition, soil moisture, residue coverage). As a result, the row unit 30 may effectively close the trench for a variety of field conditions. In combination, the parallel linkage (formed by the upper link 36 and the lower link 38), the spring assembly 70, and the packer wheel actuator 100 enable effective vertical motion of the frame 46 and parts coupled thereto (e.g., upon contact with an object in the field) and also provide adjustable downforce for ground-contacting components, such as the packer wheel 82. It should be appreciated that the row unit 30 may include multiple packer assemblies 80 supported on the frame 46 and distributed along the lateral axis 2 (e.g., side-by-side), wherein each of the multiple packer assemblies 80 includes a respective packer wheel 82, a respective packer wheel arm 84, and a respective packer wheel actuator 100 that operate as described herein.

Further, it should be appreciated that the row unit 30 with the one or more packer assemblies 80 (e.g., with the packer wheel 82) is shown and described in detail herein to facilitate detailed discussion of various structural and operational features of the row unit 30. However, unless otherwise expressly specified, the one or more packer assemblies 80 are intended to represent and refer to any of a variety of types of assemblies that may be positioned rearward of the opener relative to the forward direction of travel 18. Additionally, unless otherwise expressly specified, the packer wheel 82 is intended to represent and refer to any of a vareity of types of wheels (e.g., packer wheels, such as a wide wheels configured to pack the soil over the trench; closing wheels, such as a pair of angled closing wheels configured to push the soil into the trench; seed lock wheels, such as a narrow firming wheel that firms the soil over at the trench) that may be positioned rearward of the opener relative to the forward direction of travel 18.

In the illustrated embodiment, the row unit 30 is a seeding/seeder row unit, as compared to a planting/planter row unit. Accordingly, a storage compartment (e.g., hopper, mini-hopper) for agricultural product is not non-movably coupled to the frame 46 (e.g., as compared to a planting/planter row unit that includes an agricultural product storage compartment, such as a hopper or a mini-hopper configured to receive agricultural product from a central storage compartment, non-movably coupled to the frame). In addition, the seeding/seeder row unit 30 includes a single opener disc 52 (e.g., as compared to a planting/planter row unit that includes a pair of opener discs arranged to form a v-shaped trench). Furthermore, in the illustrated embodiment, a metering device is not non-movably coupled to the frame of the row unit (e.g., as compared to a planting/planter row unit that includes a frame-mounted metering device, such as a vacuum seed meter).

However, in other embodiments, the row unit 30 may be adapted as the planting/planter row unit and/or to have any other features, such as to have the agricultural product storage compartment, the pair of opener discs, and/or the metering device supported on the frame of the row unit. It should be appreciated that other variations and/or modifications to the row unit 30 are envisioned. For example, the opener disc 52 may be coupled to any suitable location of the frame 46, the lower link 38, and/or at the fastener 50 that provides a connection (e.g., pivot connection) between the lower link 38 and the frame 46.

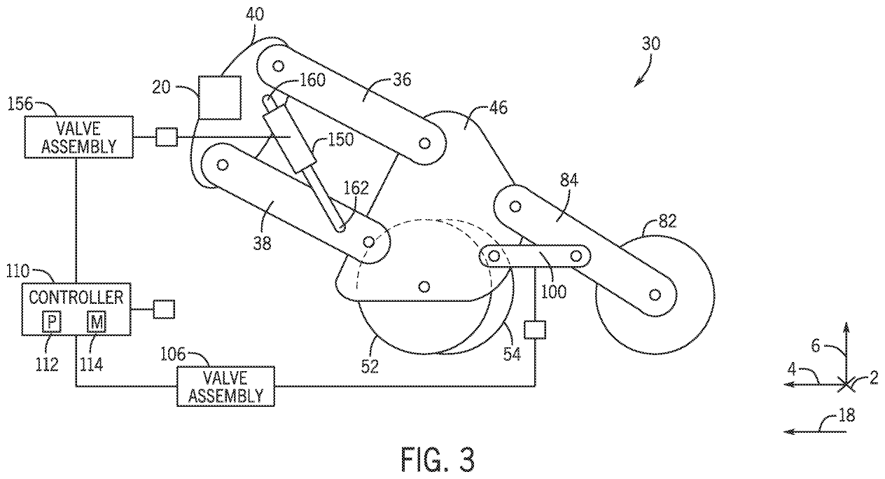

FIG. 3 is a side view of an embodiment of the row unit 30 that may be employed within the agricultural seeding implement 10 of FIG. 1, wherein multiple actuators are positioned to adjust respective downforce applied by the gauge wheel 54 and the packer wheel 82 of the row unit 30. In particular, the multiple actuators include a linkage actuator 150 that is configured to drive the lower link 38 relative to the mount 40 and the packer wheel actuator 100 that is configured to drive the packer wheel arm 84 relative to the frame 46. As a result, the linkage actuator 150 may affect and/or adjust the downforce applied by the gauge wheel 54 to the soil and the downforce applied by the packer wheel 82 to the soil. Additionally, the packer wheel actuator 100 may separately or independently affect and/or adjust the downforce applied by the packer wheel 82 to the soil.

For example, the downforce applied by the gauge wheel 54 and the downforce applied by the packer wheel 82 to the soil may be adjusted by varying a fluid pressure within the linkage actuator 150. More particularly, the downforce applied by the gauge wheel 54 and the downforce applied by the packer wheel 82 to the soil may be increased by increasing a fluid pressure within the linkage actuator 150 (e.g., to extend or lengthen the linkage actuator 150 to drive components directly or indirectly coupled thereto away from the mount 40 and toward the soil), and the downforce applied by the gauge wheel 54 and the packer wheel 82 to the soil may be decreased by decreasing the fluid pressure within the linkage actuator 150 (e.g., to compress or shorten the linkage actuator 150 to drive components directly or indirectly coupled thereto toward the mount 40 and away from the soil).

A valve assembly 156 is fluidly coupled to the linkage actuator 150. The valve assembly 156 is configured to control the fluid pressure within the linkage actuator 150, thereby adjusting the downforce applied by the gauge wheel 54 and the downforce applied by the packer wheel 82 to the soil. While the linkage actuator 150 includes the fluid actuator in the illustrated embodiment, in other embodiments, the linkage actuator may include another or an alternative suitable actuating device, such as any electromechanical actuator, any linear actuator, any rotary actuator, and so forth. Furthermore, while the linkage actuator 150 includes a single actuating device in FIG. 4, it should be appreciated that the linkage actuator 150 may include multiple actuating devices (e.g., of the same type or of different types).

The controller 110 (e.g., electronic controller) may be configured to output respective output signals to the valve assembly 156 indicative of instructions to control the linkage actuator 150 and to the valve assembly 106 indicative of instructions to control the packer wheel actuator 100. In certain embodiments, the controller 110 is configured to determine the instructions to control the linkage actuator 150 and the packer wheel actuator 100 based at least in part on respective contact forces (e.g., determined contact forces; measured contact forces) between the gauge wheel 54 and the soil and between the packer wheel 82 and the soil. For example, the controller 110 may determine respective target contact forces between the gauge wheel 54 and the soil and between the packer wheel 82 and the soil based on the soil condition(s), the residue characteristics (e.g., coverage), the trench closing effectiveness, or a combination thereof. Then, the controller 110 may control the linkage actuator 150 and the packer wheel actuator 100 such that the respective contact forces between the gauge wheel 54 and the soil and between the packer wheel 82 and the soil are maintained within respective threshold ranges of the respective target contact forces. It should be appreciated that any of a variety of sensors (e.g., downforce sensors) may be provided to output respective input signals to the controller 110 indicative of the respective contact forces and to enable feedback control of the linkage actuator 150 and/or the packer wheel actuator 100.

Because the packer wheel arm 84 is independently pivotally coupled to the frame 46 of the row unit 30, the contact force between the packer wheel 82 and the soil may be adjusted and/or supplemented substantially independently of the contact force between the gauge wheel 54 and the soil. For example, the contact force between the gauge wheel 54 and the soil may be a first value (e.g., as detected based on sensor data) due to force applied by the linkage actuator 150, and the contact force between the packer wheel 82 and the soil may be further adjusted to a second value via the packer wheel actuator 100 (e.g., the packer wheel actuator 100 may supplement the linkage actuator 150 to enable the row unit 30 to achieve the respective target contact forces for both the gauge wheel 54 and the packer wheel 82). As a result, the row unit 30 may effectively form and close the trench for a variety of field conditions. In combination, the parallel linkage (formed by the upper link 36 and the lower link 38), the linkage actuator 150, and the packer wheel actuator 100 provide vertical motion of the frame 46 and parts coupled thereto and also provide adjustable downforce for ground-contacting components, such as the gauge wheel 54 and the packer wheel 82.

As shown, a first end of the linkage actuator 150 is pivotally coupled to the mount 40 via a fastener 160 (e.g., pin), and a second end of the linkage actuator 150 is pivotally coupled to the lower link 38 by a fastener 162 (e.g., pin). However, it should be appreciated that the first end of the linkage actuator 150 may be pivotally coupled to the mount 40 via the fastener 160, and the second end of the linkage actuator 150 may be pivotally coupled to the frame 46 via a respective fastener (e.g., pin). As another example, the first end of the linkage actuator 150 may be pivotally coupled to the upper link 36 via a respective fastener, and the second end of the linkage actuator 150 may be pivotally coupled to the lower link 38 by the fastener 162 or to the frame 46 via a respective fastener (e.g., pin). As another example, the first end of the linkage actuator 150 may be pivotally coupled to the frame 46 via a respective fastener (e.g., pin), and the second end of the linkage actuator 150 may be pivotally coupled to the lower link 38 by the fastener 162. Thus, the linkage actuator 150 may be coupled to other components of the row unit 30 in any suitable arrangement that drives movement (e.g., pivoting; rotation) of the lower link 38 relative to the mount 40.

Further, it should be appreciated that other variations and/or modifications to the row unit 30 are envisioned. For example, the opener disc 52 may be coupled to any suitable location of the frame 46, the lower link 38, and/or at the fastener 50 that provides a connection (e.g., pivot connection) between the lower link 38 and the frame 46. Indeed, the linkage actuator 150 may be provided to replace the spring assembly 70 of FIG. 2 to provide additional levels or layers of dynamic control of the row unit 30, as set forth herein.

In certain embodiments, an additional actuator may be incorporated into the row unit 30 (e.g., in conjunction with any of the features shown in FIGS. 1-4 and/or described with reference to FIGS. 1-4). For example, the additional actuator may be provided between the respective toolbar 20 and the mount 40 of FIGS. 2-4. Thus, the additional actuator may be configured to drive movement (e.g., rotation; toward or away from the soil) of the mount 40 (and the components coupled thereto) relative to the respective toolbar 20. The additional actuator also may affect and/or adjust the respective downforces applied between the gauge wheel 54 and the soil and the packer wheel 82 and the soil. Accordingly, the controller 110 may dynamically control any actuators (e.g., the packer wheel actuator 100, the linkage actuator 150, and/or the additional actuator) in a coordinated manner to achieve the target downforce(s), as described herein.

For example, with reference to FIG. 2, an additional actuator 170 may apply force to the mount 40 to compress the one or more spring assemblies 70 of the one or more row units 30 (e.g., a group of row units) and/or to provide supplemental downforce to the one or more row units 30. The force applied by the additional actuator 170 may be controlled to adjust the downforce applied by the gauge wheel 54 to the soil (e.g., while compressing the spring assembly 70). In addition, the spring assembly 70 is configured to compress to facilitate upward vertical movement of the frame 46 in response to the opener disc 52 or the gauge wheel 54 encountering an obstruction (e.g., rock, branch, etc.) within the field.

The additional actuator 170 may include a fluid actuator (e.g., hydraulic cylinder, hydraulic motor, pneumatic cylinder, pneumatic motor). Accordingly, the downforce applied by the gauge wheel 54 to the soil may be increased by increasing the fluid pressure within the additional actuator 170, and the downforce applied by the gauge wheel 54 to the soil may be decreased by decreasing the fluid pressure within the additional actuator 170. Furthermore, in such embodiments, a valve assembly 172 may be fluidly coupled to the additional actuator 120. The valve assembly 172 may be configured to adjust the fluid pressure within the additional actuator 170, thereby adjusting the downforce applied by the gauge wheel 54 to the soil. In addition, the controller 110 may be communicatively coupled to the valve assembly 172. The controller 110 may be configured to output an output signal to the valve assembly 172 indicative of instructions to control the additional actuator 170 (e.g., based on soil condition(s), residue coverage, trench closing effectiveness). While a fluid actuator is disclosed herein, the additional actuator may include other or alternative suitable actuator(s), such as electromechanical actuator(s), linear actuator(s), or electric motor(s).

While only certain features have been illustrated and described herein, many modifications and changes will occur to those skilled in the art. It is, therefore, to be understood that the appended claims are intended to cover all such modifications and changes as fall within the true spirit of the disclosure. It should be appreciated that any of the features shown and described with reference to FIGS. 1-4 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A row unit system for a seeder, comprising:
a frame;
a parallel linkage configured to couple the frame to a mount associated with a toolbar of the seeder;
an opener disc rotatably coupled to the frame; and
a packer wheel assembly, comprising:
a packer wheel arm pivotally coupled to the frame;
a packer wheel rotatably coupled to the packer wheel arm; and
a packer wheel actuator pivotally coupled to the packer wheel arm and the frame, wherein the packer wheel actuator is configured to control a downforce applied by the packer wheel to soil.

2. The row unit system of claim 1, wherein the packer wheel arm is a rigid structure that positions a respective rotational axis of the packer wheel rearward of the opener disc relative to a forward direction of travel.

3. The row unit system of claim 1, wherein the packer wheel actuator is positioned vertically below a connection between the packer wheel arm and the frame.

4. The row unit system of claim 1, wherein the parallel linkage is positioned forward of the packer wheel assembly relative to a forward direction of travel.

5. The row unit system of claim 1, comprising a biasing member or an additional actuator pivotally coupled to the mount and a lower link of the parallel linkage.

6. The row unit system of claim 1, comprising an additional actuator, wherein the additional actuator is configured to control an additional downforce applied by a gauge wheel to the soil, and together the packer wheel actuator and the additional actuator are configured to control the downforce applied by the packer wheel to the soil.

7. The row unit system of claim 6, comprising a controller configured to control the additional actuator and the packer wheel actuator to maintain the additional downforce and the downforce within respective ranges of respective target values.

8. The row unit system of claim 1, comprising a controller configured to control the packer wheel actuator to maintain the downforce within a range of a target value.

9. The row unit system of claim 8, wherein the controller is configured to receive sensor data indicative of field conditions and determine the target value based on the field conditions.

10. The row unit system of claim 9, comprising a downforce sensor communicatively coupled to the controller and configured to generate an input signal indicative of the downforce applied by the packer wheel to the soil.

11. The row unit system of claim 1, wherein an extension of the packer wheel actuator is configured to decrease the downforce applied by the packer wheel to the soil, and a retraction of the packer wheel actuator is configured to increase the downforce applied by the packer wheel to the soil.

12. The row unit system of claim 1, wherein the packer wheel actuator comprises a fluid actuator.

13. A row unit system for a seeder, comprising:
a frame;
a parallel linkage configured to couple the frame to a mount associated with a toolbar of the seeder;
an opener disc rotatably coupled to the frame;
a packer wheel assembly, comprising:
a rigid packer wheel arm pivotally coupled to the frame;
a packer wheel rotatably coupled to the rigid packer wheel arm; and
a packer wheel actuator pivotally coupled to the rigid packer wheel arm and the frame; and
a controller configured to control a valve assembly to control a downforce applied by the packer wheel to soil.

14. The row unit system of claim 13, wherein the controller is configured to control the valve assembly to extend the packer wheel actuator to decrease the downforce applied by the packer wheel to the soil and to retract the packer wheel actuator to increase the downforce applied by the packer wheel to the soil.

15. The row unit system of claim 13, wherein the controller is configured to control the valve assembly to maintain the downforce applied by the packer wheel within a range of a target downforce.

16. The row unit system of claim 15, wherein the controller is configured to receive sensor data and determine the target downforce based on the sensor data.

17. The row unit system of claim 13, wherein the packer wheel actuator is positioned below a connection between the rigid packer wheel arm and the frame relative to a vertical axis.

18. The row unit system of claim 13, wherein a first end of the packer wheel actuator is coupled to the frame at a first location that is below a connection between the rigid packer wheel arm and the frame relative to a vertical axis, and a second end of the packer wheel actuator is coupled to a center portion of the rigid packer wheel arm located between the connection and an axle of the packer wheel.

19. The row unit system of claim 13, comprising a biasing member or an additional actuator pivotally coupled to the mount and at least one of the frame, a lower link of the parallel linkage, and the opener disc.

20. A method of operating a row unit system for a seeder, the method comprising:
linking, via a parallel linkage, a frame of a row unit to a mount associated with a toolbar of the seeder;
positioning an opener disc in contact with soil in a field, wherein the opener disc is rotatably coupled to the frame;
positioning a packer wheel in contact with the soil in the field, wherein the packer wheel is rotatably coupled to a rigid packer wheel arm, and the rigid packer wheel arm is pivotally coupled to the frame; and
controlling a valve assembly to increase a fluid pressure at a packer wheel actuator that is coupled to the rigid packer wheel arm to thereby decrease a downforce applied by the packer wheel to the soil in the field.
